(19) United States
(12) Patent Application Publication
(10) Pub. No.: US 2005/0284452 A1
(43) Pub. Date: Dec. 29, 2005

(54) Low pressure secondary regulator for gaseous fuels

(76) Inventor: Paul L. Martin, Sun Prairie, WI (US)

Correspondence Address: Paul L. Martin, 1396 Troon Drive, Sun Prairie, WI, 53590, US

(21) Appl. No.: 11/121,364

(22) Filed: Aug. 4, 2005

Related U.S. Application Data
(60) Provisional application No. 60/583,331, filed on Jun. 28, 2004.

(51) Int. Cl. F02B 43/00

(52) U.S. Cl. 123/527

(57) ABSTRACT

A low pressure secondary regulator for gaseous fuels for industrial engines that are configured to function on gaseous fuels primarily on propane or natural gas. The GFR (Gaseous Fuel Regulator) is designed to receive gaseous fuel at low pressure (6 oz. or 11 w.c.) and 1. Govern the fuel requirements to the engine, 2. Seal off fuel supply when engine is not in operation. The inventive device includes: Valve Seat Assembly, Control Lever, Magnetic Sensitivity Control, Maximum Fuel Limit Set Screw, and Diaphragm. The valve seat assembly consists of a tapered valve seat and plunger with o-ring. The control lever is long and narrow with one 90 deg. bend. The magnetic sensitivity control involves the use of two magnets. The fuel limit set screw is fabricated from threaded rod. The diaphragm consists of a thin silicon liner with a rigid center and a spring clip.

### BACKGROUND OF THE INVENTION

1. Field of the Invention

The present invention relates generally to secondary regulator and more specifically it relates to a low-pressure secondary regulator for gaseous fuels for industrial engines that are configured to function on gaseous fuels primarily on propane or natural gas. The GFR (Gaseous Fuel Regulator) is designed to receive gaseous fuel at low pressure (6 oz. or 11 w.c.). And uniquely: 1. Precisely meter fuel. 2. Govern the fuel requirements to the engine, 3. Provide positive lock off pressure to prevent fuel flow when engine is not in operation.

2. Description of the Prior Art

It can be appreciated that secondary regulator have been in use for years. Typically, secondary regulator are comprised of Impco Equipment type Document 1:“KN zero pressure regulator” and Document 2: Beam type “202A zero pressure regulator”. Both 1&2 are manufactured by Impco Technologies based out of Cerritos, Calif. (www.impcotechnoologies.com).

The main problem with conventional secondary regulator are that with both regulators under increased pressure above 15 inches of water column pressure, the retaining valve could unseat allowing gaseous fuel to leak. This problem is due to the fact that the valve seats against pressure. Additional components are required to overcome this limitation, which adds to complexity and installation time. Another problem with conventional secondary regulator are that with both competitors regulators, the valve seat is flush and opens parallel to the fuel inlet. Another problem with conventional secondary regulator are that with both competitors regulators cannot by them selves provide variable fuel flow rate.

While these devices may be suitable for the particular purpose to which they address, they by themselves are not as suitable for industrial engines that are configured to function on gaseous fuels primarily on propane or natural gas without the aid of several additional components.

The GFR (Gaseous Fuel Regulator) is designed to receive gaseous fuel at low pressure (6 oz. or 11 w.c.) and 1. Govern the fuel requirements to the engine, 2. Seal off fuel supply when engine is not in operation. The main problem with conventional secondary regulator are that with both competitors regulators under increased pressure above 15 inches of water column pressure, the retaining valve could unseat allowing gaseous fuel to leak. This problem is due to the fact that the valve seats against pressure. Additional components are required to overcome this limitation which adds to complexity and installation time. Another problem is that with both competitors' regulators, the valve seat is flush and opens parallel to the fuel inlet. Also, another problem is that with both competitors regulators cannot by them selves regulate maximum fuel flow.

In these respects, the low-pressure secondary regulator for gaseous fuels according to the present invention substantially departs from the conventional concepts and designs of the prior art, and in so doing provides an apparatus primarily developed for the purpose of industrial engines that are configured to function on gaseous fuels primarily on propane or natural gas. The GFR (Gaseous Fuel Regulator) is designed to receive gaseous fuel at low pressure(6 oz. or 11 w.c.) and 1. Govern the fuel requirements to the engine, 2. Seal off fuel supply when engine is not in operation.

### SUMMARY OF THE INVENTION

In view of the foregoing disadvantages inherent in the known types of secondary regulator now present in the prior art, the present invention provides a new low pressure secondary regulator for gaseous fuels construction wherein the same can be utilized for industrial engines that are configured to function on gaseous fuels primarily on propane or natural gas. The GFR (Gaseous Fuel Regulator) is designed to receive gaseous fuel at low pressure (6 oz. or 11 w.c.) and 1. Govern the fuel requirements to the engine, 2. Provide positive lock off pressure to prevent fuel flow when engine is not in operation.

The general purpose of the present invention, which will be described subsequently in greater detail, is to provide a new low pressure secondary regulator for gaseous fuels that has many of the advantages of the secondary regulator mentioned heretofore and many novel features that result in a new low pressure secondary regulator for gaseous fuels which is not anticipated, rendered obvious, suggested, or even implied by any of the prior art secondary regulator, either alone or in any combination thereof.

To attain this, the present invention generally comprises: Valve Seat Assembly , Control Lever, Magnetic Sensitivity Control, Maximum Fuel Limit Set Screw, and Diaphragm. The valve seat assembly consists of a tapered valve seat and plunger with o-ring. The control lever is long a narrow with one 90 deg. bend. The magnetic sensitivity control involves the use of two magnets. The fuel limit set screw is fabricated from threaded rod. The diaphragm consists of a thin silicon liner with a rigid center and a spring clip.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a low-pressure secondary regulator for gaseous fuels that will overcome the shortcomings of the prior art devices.

An object of the present invention is to provide a low-pressure secondary regulator for gaseous fuels for industrial engines that are configured to function on gaseous fuels primarily on propane or natural gas. The GFR (Gaseous Fuel Regulator) is designed to receive gaseous fuel at low pressure(6 oz. or 11 w.c.) and 1. Govern the fuel requirements to the engine, 2. Seal off fuel supply when engine is not in operation.

Another object is to provide a low pressure secondary regulator for gaseous fuels that will better meter a gaseous fuel. This is accomplished by having a tapered valve seat vs. a flat seal surface.

Another object is to provide a low-pressure secondary regulator for gaseous fuels that will allow a valve to seat with the gaseous fuel inlet pressure. This would remove the potential threat of leaking if inlet fuel pressure were too excessive.

Another object is to provide a low-pressure secondary regulator for gaseous fuels that will limit maximum fuel flow.

Other objects and advantages of the present invention will become obvious to the reader and it is intended that these objects and advantages be within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

The GFR body is machined from aluminum. It comprises of the diaphragm top cover, diaphragm base mount, and the valve body. Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 on next page is top and side view of GFR regulator.

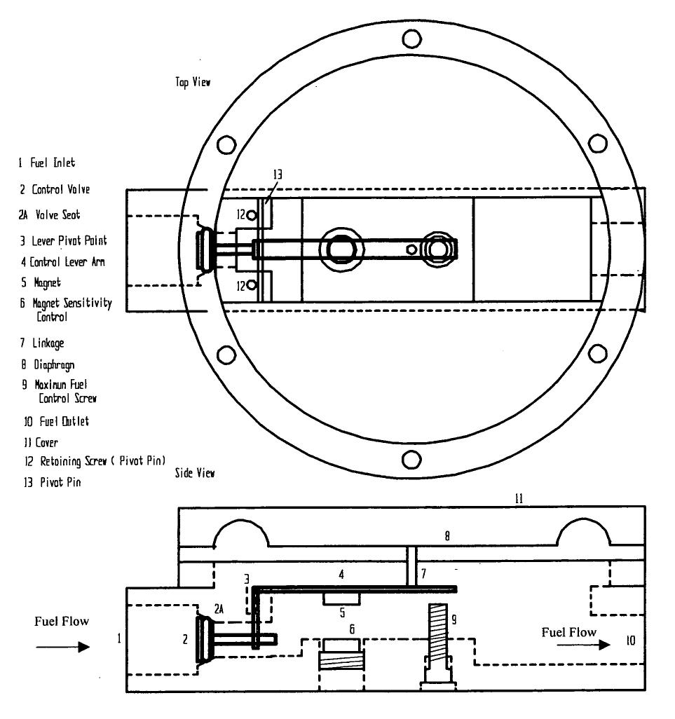

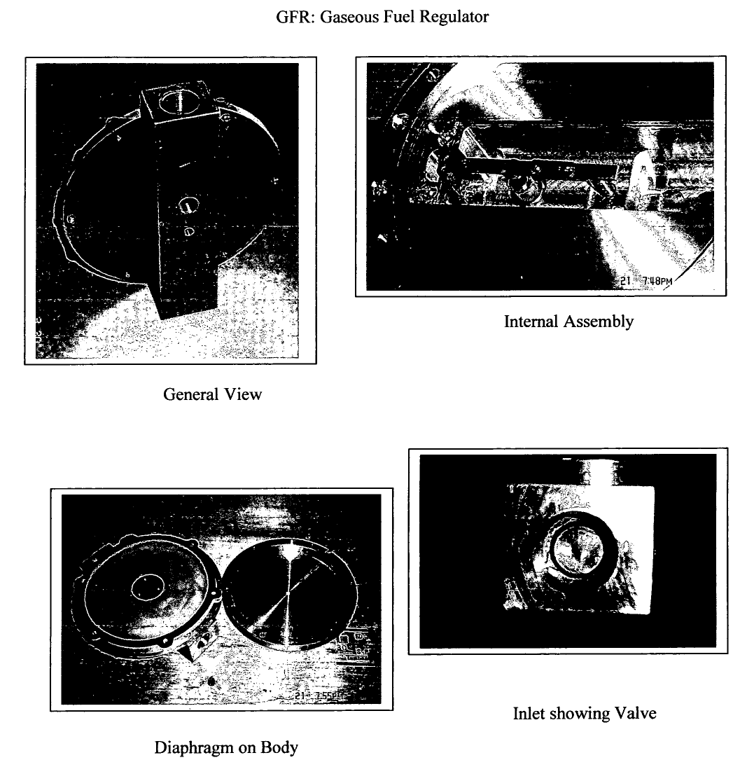

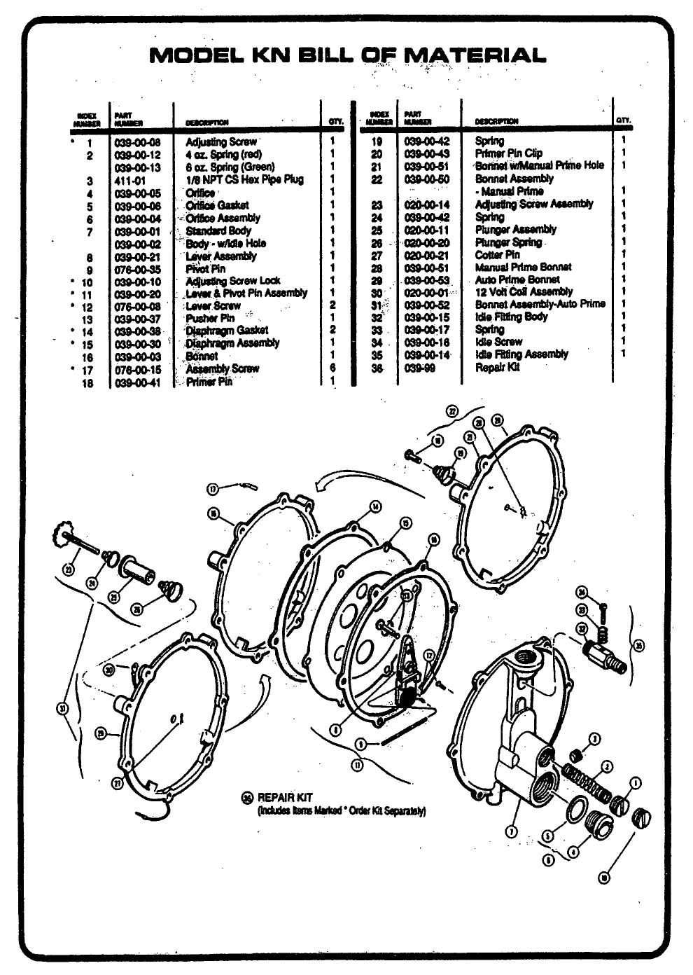

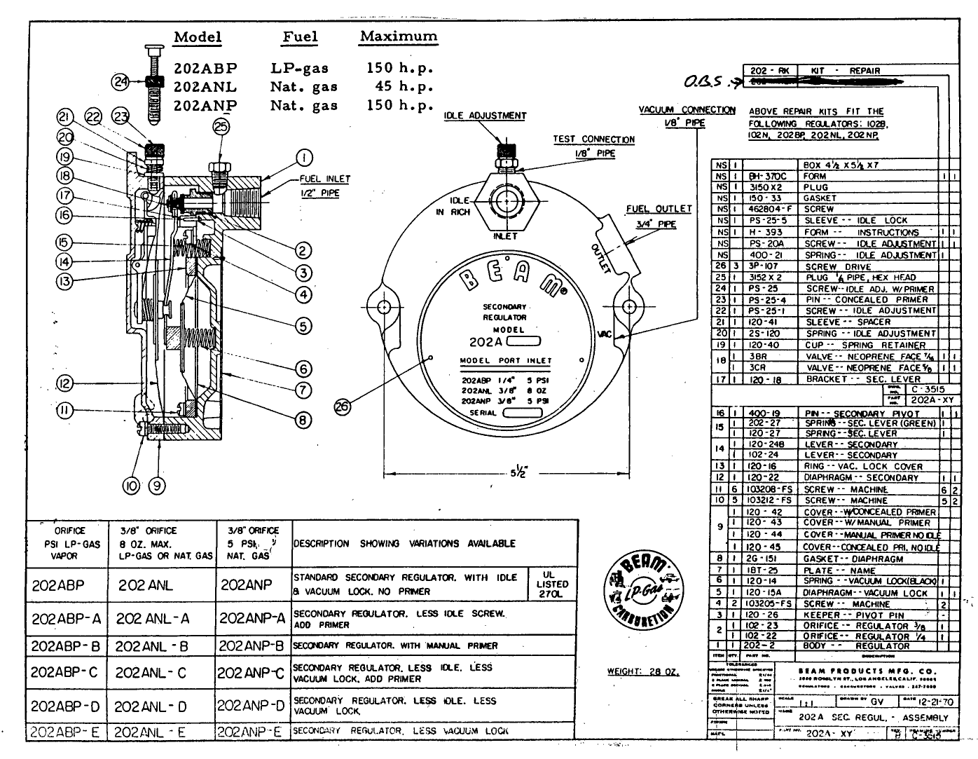

1. A. A limitation with prior art doc. #1 & #2 is that they do not have precise fuel metering capability.
In regards to FIG. 1 GFR drawing, item 9 fuel control screw, provides precise fuel meeting by controlling the travel of item # 4 control arm. The control arm item # 4 is connected to item #2 control valve. Depending on the depth of the item #9 fuel control screw, will control the amount of fuel by the travel of item#2 control valve.
B. A limitation with prior art doc. 1, item 2 and prior art doc. 2, item 6, is that they have a fixed resistance due to a spring tension only. This will not allow for efficient burn of fuel during changes with engine load demands.
In regards to FIG. 1 GFR, item 5&6 magnet sensitivity control, a variable current can control the resistance from an electrical input if required. This offers precise fuel burn emissions control.
C. A limitation with prior art doc. #1, item 8 lever assembly/seal & prior art doc. #2, item 18 valve, is that they both seat against pressure and open with pressure. The danger is if pressure exceeds 20 oz, it will unseat letting unwanted fuel leak into the engine and then to the atmosphere.
In regards to the GFR FIG. 1, item 2 control valve, seats with pressure and opens against pressure. The seat would remain closed up to pressures of 312 psi or more.
Description of the Prior Art
It can be appreciated that secondary regulator have been in use for years. Typically secondary regulators are comprised of Impco Equipment type prior art document 1: “KN zero pressure regulator” and prior art document 2: Beam type “202A zero pressure regulator”. Both prior art 1&2 are manufactured by Impco Technologies based out of Cerritos, Calif. (www.impcotechnoologies.com).
